(19) United States
(12) Patent Application Publication
(10) Pub. No.: US 2019/0264473 A1
(43) Pub. Date: Aug. 29, 2019

(54) ARRANGEMENT FOR ACTUATING A COMPONENT OF A VEHICLE

(71) Applicant: ILLINOIS TOOL WORKS INC., GLENVIEW, IL (US)

(72) Inventors: Zsolt WILKE, Bad Mergentheim (DE); Roland OCH, Rottendorf (DE); Joachim OBERST, Grossrinderfeld (DE); Matthias SEUBERT, Giebelstadt (DE)

(21) Appl. No.: 16/342,633

(22) PCT Filed: Oct. 11, 2017
(86) PCT No.: PCT/US2017/056088

§ 371 Date: Apr. 17, 2019

(30) Foreign Application Priority Data
Oct. 18, 2016 (DE) 10 2016 119 832.3

(51) Int. Cl. E05B 77/06; E05B 85/10; E05B 81/00; H01H 35/14

(52) U.S. Cl. CPC E05B 77/06; E05B 85/103; E05Y 2900/531; H01H 35/14; E05B 81/00

(57) ABSTRACT

An arrangement for actuating a component of a vehicle, wherein the component has a manually actuable actuating portion which is mounted on the vehicle so as to be movable between a closed position and an open position, wherein the arrangement comprises a control element and an electric drive which is connected to the control element via an electrical connection, wherein, when the actuating portion moves into its open position, the control element activates the electric drive, and therefore the electric drive actuates the component, wherein a centrifugal weight element is mounted movably on the arrangement, wherein the centrifugal weight element is moved from an inoperative position into an interruption position by a predetermined acceleration acting on the component and moving the actuating portion into the open position, wherein, in the interruption position, the centrifugal weight element interrupts the electrical connection between the control element and the electric drive.

### TECHNICAL FIELD

The invention relates to an arrangement for actuating a component of a vehicle, wherein the component has a manually actuable actuating portion which is mounted on the vehicle so as to be movable between a closed position and an open position, wherein the arrangement comprises a control element and an electric drive which is connected to the control element via an electrical connection, wherein, when the actuating portion moves into its open position, the control element activates the electric drive, and therefore the electric drive actuates the component.

### BACKGROUND

For example, door handle arrangements of vehicles such as automobiles regularly comprise devices which prevent an unintentional opening of the door in event of a crash of the vehicle, such as a side impact. Mechanical inertia locking elements are known, which block the opening of the door upon occurrence of a certain acceleration, especially an acceleration which occurs during a crash. Such mechanical inertial locking devices once again allow the door to be opened when the forces are no longer present. Such door handle arrangements are known, for example, from DE 10 2013 006 826 A1 and DE 10 2014 107 861 A1. They afford a high operating safety for door handle arrangements with door locks which are mechanically unlocked and doors which are opened.

On the other hand, arrangements are known which electrically actuate the components of a vehicle, such as a door lock of a vehicle door, and optionally also the vehicle door. These comprise an electrical drive unit, which is actuated by a control element and activates the component. There is also provided in such electrically operating components an activation element, such as a manually grasped or otherwise activatable handle portion which can be moved manually from a closed position to an open position. In the open position, the electrical drive unit is actuated by the control element to activate the component. Also in such arrangements an unwanted activating of the component should be securely prevented, such as an opening of a vehicle door in event of a crash.

Present-day vehicles are generally outfitted with many crash sensors to determine a crash situation. Thus, one might conceive of preventing the actuating of the electric drive by the control element through the vehicle's electronics upon determining a crash situation. However, the actuating of the electric drive and thus the activating of the component cannot always be prevented fast enough in this way. Therefore, there is a risk that an activating of the component will occur already in a crash situation before a signal arrives to prevent the actuating of the electric drive.

### SUMMARY

Proceeding from the prior art, the problem which the invention proposes to solve is therefore to prevent an unintentional activating of the component in event of a crash in the case of an electrically operated arrangement of the aforementioned kind.

The invention solves the problem by the subject matter of independent claim 1. Advantageous embodiments will be found in the dependent claims, the description, and the figures.

For an arrangement of the kind mentioned at the outset, the invention solves the problem in that a centrifugal weight element is mounted movably on the arrangement, wherein the centrifugal weight element is moved from an inoperative position into an interruption position by a predetermined acceleration acting on the component and moving the actuating portion into the open position, wherein, in the interruption position the centrifugal weight element interrupts the electrical connection between the control element and the electric drive.

The vehicle outfitted with the arrangement according to the invention may be an automobile. The component may be an electrically activated, especially an electrically opening component movably mounted in the interior of the vehicle or on the outside. For example, the component may be a door lock or a vehicle door. But it may also be, for example, a trunk hood, an engine hood, a glove compartment, an ash tray, a cup holder or the like. Insofar as the arrangement is a door handle arrangement for the activating of a door lock or a door of the vehicle, the door handle arrangement may be for example an outer door handle arrangement. The actuating portion may be mounted by a bearing portion movably on the vehicle, for example the vehicle door. For example, the actuating portion may be mounted pivotably on the vehicle, especially about a vertical pivot axis during operation of the vehicle. But a translatory movable mounting is also conceivable. The mobility of the actuating portion may also be very slight, for example, if the actuating portion is designed as a switch, as will be described below. The actuating portion may also be a simple push button. In the closed position the actuating portion may be flush with a surrounding portion, such as a portion of the vehicle body.

In the arrangement according to the invention, a mechanical manual movement of the actuating portion brings about an electrically operated activating of the component, especially an opening of the component. If the actuating portion is moved by a user of the vehicle from its closed position to its open position, the control element, such as an electrical switch, will actuate the electrical drive, such as an electrical motor or several electrical motors. The electrical drive thereupon activates the component, for example opens it. For example, the electrical drive may unlock a door lock. As explained, the electrical drive may also open the vehicle door electrically, for example in the case of a folding door or the like.

According to the invention, a centrifugal weight element is mounted on the arrangement able to move between an inoperative position and an interruption position. In the inoperative position, the electrical drive is connected via an electrical connection to the control element. Upon occurrence of an acceleration of predetermined magnitude acting on the arrangement, especially a magnitude such as occurs during a vehicle crash, which then tries to move the actuating portion to the open position, the centrifugal weight element is moved by this acceleration from its inoperative position to an interruption position. In the interruption position, the electrical connection between the control element and the electrical drive is broken. Thus, if the control element tries to actuate the electrical drive to activate the component on account of the movement of the actuating portion to the open position due to the acceleration, this will be prevented according to the invention by the interrupted electrical connection. This ensures, by mechanical means in a simple and quick manner, even in the case of an electrical activation of vehicle components such as the vehicle door or the door lock, that there can be no unintentional activating or opening of the component in the event of a vehicle accident, especially a side impact.

The actuating portion and/or the centrifugal weight element automatically move back to the closed position or the inoperative position when the forces are then absent. In particular, the actuating portion and/or the centrifugal weight element may be prestressed in the closed position or the inoperative position. The prestressing may be provided in each case by a suitable spring element or also by gravity. Thus, after a vehicle accident, the component may be opened once more, for example in the case of a vehicle door in order to free passengers from the crashed vehicle.

Thus, owing to the mechanically working device according to the invention for preventing an unintentional activating of the component, the safety is optimized in simple manner, even in the case of electrically operated components. The device according to the invention does not intervene directly in the mechanical movement of the actuating portion here. Thus, the device, especially the centrifugal weight element, may also be arranged outside the component. But of course the arrangement may also be integrated in the component.

According to one embodiment, it may be provided that the actuating portion is movable from the closed position into the open position by manual pressing-in and/or manual pulling-out and/or manual rotation, and that the control element comprises a switch, in particular a micro-switch, which is actuated by the movement of the actuating portion into the open position. In this embodiment, the user presses the actuating portion from the inoperative position, for example somewhat in the direction of the car body. In this way, a switch is activated, which in turn activates the electrical drive for activating the component via the electrical connection. The actuating portion in this embodiment thus acts like a switch. For example, it may be provided that the actuating portion must be pressed, pulled out, and/or held in a rotated position for a minimum time, for example at least 20 ms, in order to send the opening signal to the electrical drive.

According to another embodiment, it may be provided that the electrical connection between the control element and the electric drive comprises an elastically deformable contact tab and a contact portion, which is connected in an electrically conductive manner to the contact tab in an inoperative position of the contact tab, wherein, when the centrifugal weight element moves into the interruption position, the contact tab is deformed from the inoperative position into an interruption position in which the electrically conductive connection with the contact portion is interrupted. The contact tab is prestressed in its inoperative position, in which it is connected in electrically conductive manner to the contact portion. From this inoperative position, it can be deflected by the centrifugal weight element moving into the interruption position against its prestressing and into an interruption position under elastic deformation. In the interruption position, the contact tab is lifted off from the contact portion and thus the electrically conductive connection is interrupted. For example, the contact portion may be a stationary contact tongue.

According to another embodiment in this regard, it may be provided that the centrifugal weight element is a centrifugal weight ball which is mounted in a receptacle below the contact tab, wherein the receptacle has a central region of greatest depth that receives the centrifugal weight ball in its inoperative position, and wherein the depth of the receptacle is reduced from the central region of greatest depth toward the edge of the receptacle, wherein the centrifugal weight ball is moved from the central region of greatest depth to the edge of the receptacle by the predetermined acceleration which acts on the component and moves the actuating portion into the open position. The centrifugal weight ball may be in particular a metal centrifugal weight ball, more preferably a steel centrifugal weight ball. The centrifugal weight ball is located in a receptacle beneath the contact tab. In the inoperative position of the centrifugal weight ball, it lies beneath the contact tab, so that this lies against the contact portion. At the same time, the contact tab may lie against the centrifugal weight ball. Owing to the predetermined acceleration acting on the component and moving the actuating portion into the open position, the centrifugal weight ball is moved from the central region of greatest depth to the edge of the receptacle, into its interruption position. Due to the bottom of the receptacle rising toward the edge of the depression, the centrifugal weight ball is moved upward and thereby pushes the contact tab from its inoperative position to its interruption position, in which it is lifted off from the contact portion and the electrical connection is broken. The elastic deformation of the contact tab from its inoperative position to its interruption position occurs here against its prestressing. This design is distinguished on the one hand by an especially simple construction with few parts and an easy installation. Furthermore, owing to the design of the centrifugal weight element as a centrifugal weight ball and thus the ability to move in the most diverse of directions, the interruption of the electrical connection according to the invention may operated in the most diverse of crash situations or crash directions.

The centrifugal weight ball is pre-tensioned into its inoperative position by the contact tab. As already explained, the contact tab upon occurrence of a predetermined acceleration is pressed by the centrifugal weight ball rolling into its interruption position against its prestress into its interruption position. When the forces are then absent, the contact tab in this embodiment presses the centrifugal weight ball back into the central region of greatest depth of the receptacle due to its prestress. The prestressing of the contact tab into its inoperative position therefore also prestresses the centrifugal weight ball into its inoperative position in especially simple manner. A separate spring element or the like is not required.

The receptacle may be rotationally symmetrical in design. However, this is not mandatory. Moreover, the receptacle may have the shape of a cone or a truncated cone, or the receptacle may be curved (concavely), preferably spherically curved. The receptacle may have a circular round edge. In a rotationally symmetrical design of the receptacle, the centrifugal weight ball may be moved in the most diverse of directions from the central region of greatest depth toward the edge and thus into its interruption position. In this way, predetermined accelerations acting in virtually any direction may be utilized to move the centrifugal weight ball into its interruption position and thus interrupt the electrical connection between the control element and the electrical drive. This creates safety in the most diverse accident situations against an unintentional activating of the component, for example, a side impact from various directions, a side offset collision, or a rollover of the vehicle. Furthermore the receptacle may be curved so that the restoring force acting on the centrifugal weight ball upon moving from the central region of greatest depth toward the edge of the receptacle is the same in all directions of movement of the centrifugal weight ball. The surface may resemble a sphere, but also in particular it may depart from a rotationally symmetrical shape in order to achieve the aforementioned function. Thus, the contact tab will be deflected upon movement of the centrifugal weight ball by a distance X in a first direction differently than that for a movement of the centrifugal weight ball by the distance X in a second direction. Then each time a different restoring force would also act on the ball given a rotationally symmetrical spherical configuration of the receptacle. On the other hand, by a suitable geometry of the receptacle, especially one departing from a rotational symmetry, the restoring force may be held constant in every direction of the distance X. Of course, in certain applications it may also be desirable to achieve special restoring properties in a particular direction, i.e., to design the restoring force as not equal in all directions of movement of the centrifugal weight ball. In this case as well, a non-rotationally symmetrical configuration of the receptacle may be expedient.

According to an alternative embodiment, it may be provided that the centrifugal weight element is a centrifugal weight arm which is below the contact tab, is mounted pivotably about a pivot axis and is pivoted by the predetermined acceleration, which acts on the component and moves the actuating portion into the open position, from an inoperative position into an interruption position in which the centrifugal weight arm presses the contact tab from its inoperative position into its interruption position.

The centrifugal weight arm may have at least one protrusion, which presses the contact tab from its inoperative position upward from the contact portion into its interruption position upon a pivoting of the centrifugal weight arm into the interruption position. The design with a centrifugal weight arm requires especially little space and may thus be preferable in some applications. On the other hand, it does not afford the possibility of utilizing accelerations acting in virtually any direction in order to interrupt the electrical connection between control element and electrical drive. But this might not be a problem, depending on the application.

In particular, it is possible that the centrifugal weight arm is pivotable in two opposed pivoting directions from its inoperative position into its interruption position. The centrifugal weight arm may then prevent in each case an unintentional activating of the component in two opposite directions upon occurrence of a predetermined acceleration, for example a side impact in opposite directions. For this, the centrifugal weight arm may have two protrusions, for example, one of which each time depending on the pivoting direction presses the contact tab upward from its inoperative position, away from the contact portion, into its interruption position, upon a pivoting of the centrifugal weight arm into the interruption position.

The centrifugal weight arm may be prestressed into its inoperative position by a spring element. The spring element may be, for example, a helical spring enclosing the pivot axis of the centrifugal weight arm.

As explained, the component may be a door lock, which is unlocked by the electrical drive of the arrangement according to the invention. It is also conceivable, as explained, for the component to be a vehicle door, which is opened by the electrical drive of the arrangement according to the invention. Accordingly, the invention also relates to a vehicle door of a vehicle with at least one door lock and at least one arrangement according to the invention interacting with the door lock. The invention also relates to a vehicle with such a vehicle door.

### BRIEF DESCRIPTION OF THE DRAWINGS

Exemplary embodiments of the invention shall be explained more closely below with the aid of the figures. There are shown schematically:

FIG. 1 an arrangement according to the invention in a cross section view,

FIG. 2 a portion of the arrangement shown in FIG. 1 in a perspective view according to a first exemplary embodiment,

FIG. 3 a cross section view through the part of the arrangement according to the invention shown in FIG. 2,

FIG. 4 another partial perspective view of the part of the arrangement according to the invention shown in FIG. 2,

FIG. 5 another partial perspective view of the part of the arrangement according to the invention shown in FIG. 2,

FIG. 6 a portion of the arrangement shown in FIG. 1 according to another exemplary embodiment in a perspective view, and

FIG. 7 a side view of the part shown in FIG. 6.

Unless otherwise indicated, the same reference numbers in the figures designate the same objects.

### DETAILED DESCRIPTION

The invention shall be described below making reference to the figures on the example of a door handle arrangement for the activating, especially the unlocking of a door lock or for the activating, especially the opening of a vehicle door. It is pointed out that this is only an exemplary embodiment of an arrangement according to the invention. As explained in the beginning, the arrangement according to the invention can also be provided for other electrically operated components of a vehicle.

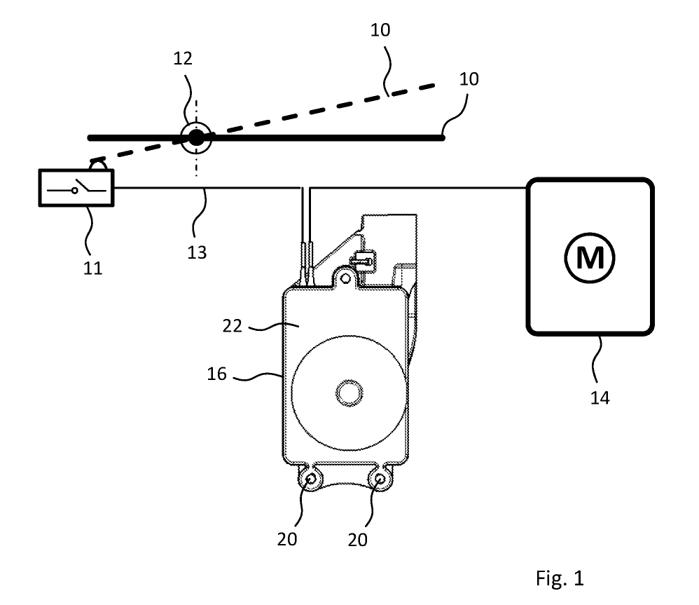

The door handle arrangement shown in FIG. 1 comprises an actuating portion 10, which in the example shown is mounted on a vehicle door by a bearing portion 12 so that it can move, in particular pivot, between a closed position and an open position, shown by broken lines. Due to the movement of the actuating portion 10, a micro-switch 11 forming a control element 11 in the example shown is activated and thereupon actuates, by an electrical connection shown at reference number 13 in FIG. 1, an electrical drive 14 to unlock the door lock of the vehicle door and optionally to open the vehicle door. Furthermore, at reference number 16 in FIG. 1 there is shown a housing of a device according to the invention, which prevents an unintentional opening of the vehicle door in event of a crash.

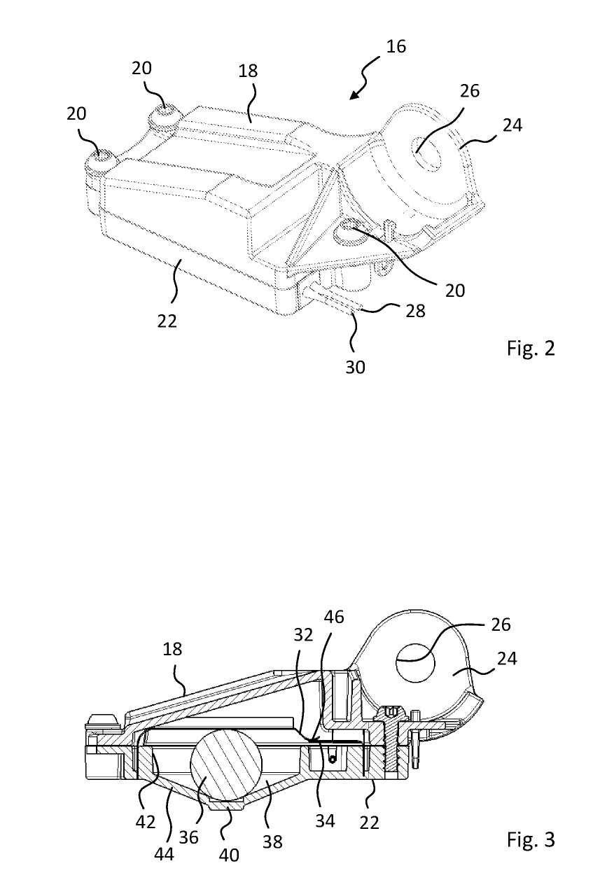

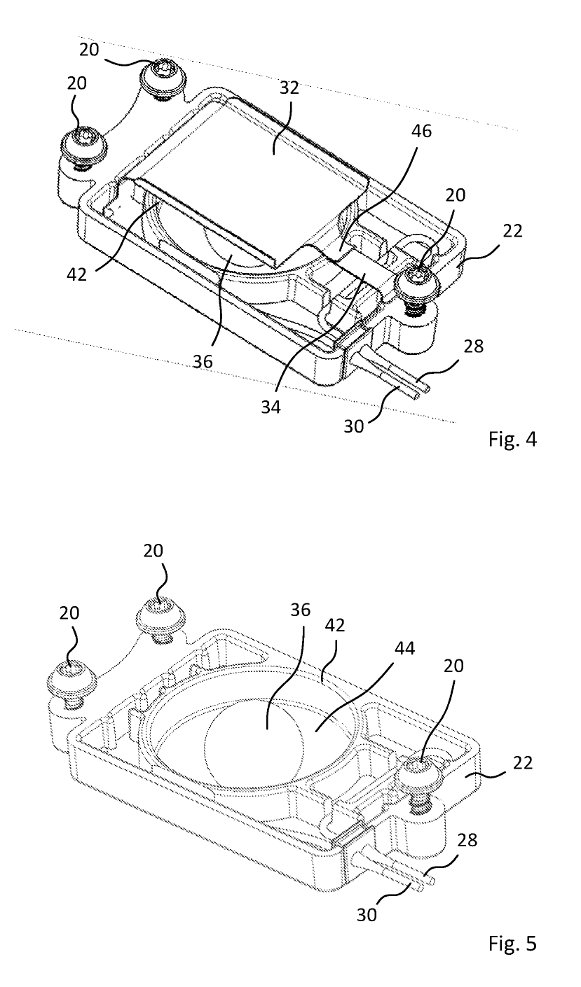

This device is explained more closely in FIG. 2 for a first exemplary embodiment. The housing 16 comprises a top part 18, which is joined by screw connections 20 to a bottom part 22. By a fastening shoulder 24 with a borehole 26, the housing 16 can be attached to a bearing portion, such as the bearing portion 12. At reference numbers 28 and 30 in FIG. 2, electrical lines are represented partially. These are part of the electrical connection 13 between the control element 11 and the electrical drive 14. The electrical lines 28, 30 are interconnected within the housing 16 in the operating position shown in FIG. 3 by an elastically deformable contact tab 32 and a contact portion 34 situated underneath, in the present case a contact tongue 34. In FIG. 4, for reasons of clarity, the top part 18 of the housing 16 has been removed. In FIG. 5, for reasons of further illustration, the contact tab 32 and the contact portion 34 have been omitted.

Beneath the contact tab 32 there is found a centrifugal weight ball 36 in a receptacle 38. The receptacle 38 has a central region 40 of greater depth, in which the centrifugal weight ball 36 is located in the inoperative position shown in FIGS. 3 to 5. In this inoperative position, the contact tab 32 is also in its inoperative position and lies on the one hand against the contact portion 34 and on the other hand against the centrifugal weight ball 36, as can be seen especially in FIGS. 3 and 4. In the example shown, the receptacle 38 has an edge 42. Starting from the central region 40 of greatest depth, the bottom of the receptacle 38 rises as a truncated cone toward the edge 42, as can be seen in FIG. 3 at reference number 44. If an acceleration of a predetermined magnitude is acting on the door handle arrangement, such as occurs in particular during a crash, the centrifugal weight ball 36 is moved by virtue of its inertia toward the edge 42 of the receptacle 38. The direction of movement of the centrifugal weight ball 36 is dependent here on the direction of the acting acceleration. Owing to the design of the receptacle 38, accordingly, virtually any given directions of acceleration will result in a movement of the centrifugal weight ball 36 in the direction of the edge 42. Because of the bottom rising in the direction of the edge 42 of the receptacle 38, the centrifugal weight ball 36 during this movement presses the contact tab 32 upward under elastic deformation from its inoperative position, so that it is lifted off from the contact portion 34, especially with the curved end portion 46. In this way, the electrical connection is broken between the contact tab 32 and the contact portion 34 and thus between the electrical lines 28 and 30 and thus finally between the control element 11 and the electrical drive 14. An unintentional opening of the vehicle door in event of a crash is thereby securely prevented.

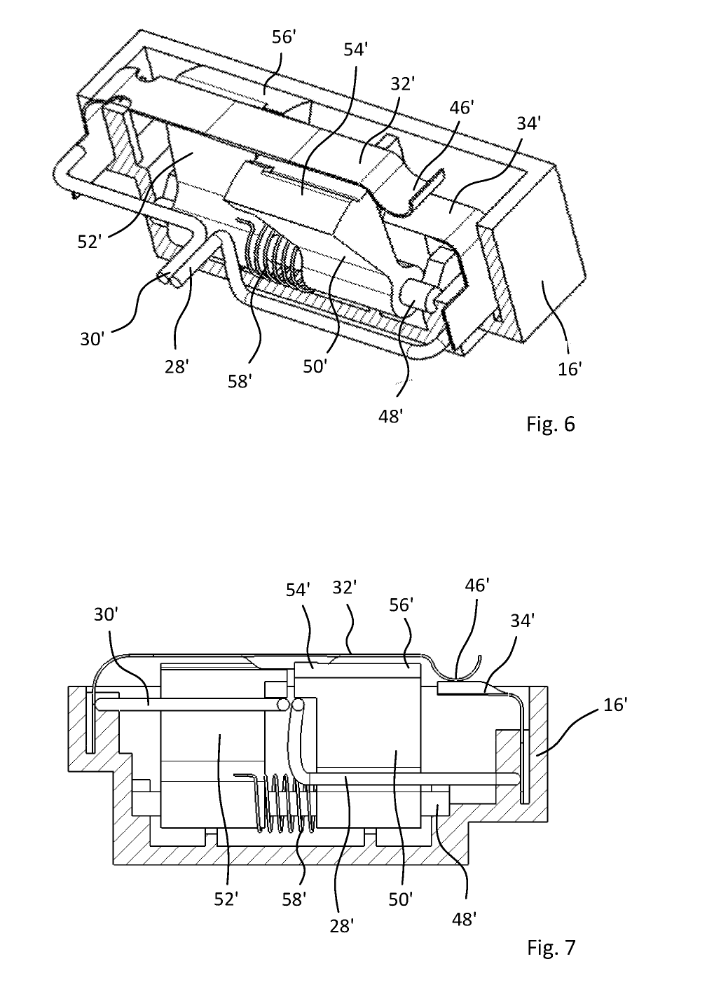

In FIGS. 6 and 7 another exemplary embodiment of a device for preventing an unintentional opening of the vehicle door is shown, which can be used in the door handle arrangement shown in FIG. 1. Here, a housing 16′ of the device is partly cut away for reasons of illustration. Again, at reference number 32′, there is shown an elastic contact tab with a curved end portion 46′. In the inoperative position shown in FIGS. 6 and 7, the contact tab 32′ lies by the end portion 46′ against a contact portion 34′ and in this way connects the electrical lines 28′, 30′ and thus the control element 11 and the electrical drive 14 to each other. As the centrifugal weight element in the embodiment according to FIGS. 6 and 7, a centrifugal weight arm mounted so that it can swivel about a pivot axis 48′ is provided. The centrifugal weight arm has two arm portions 50′, 52′ arranged at an angle to each other, with a protrusion 54′, 56′ formed each time at their free ends facing away from the pivot axis 48′. By a spring element, in the present case a helical spring 58′, the centrifugal weight arm is prestressed in the inoperative position shown in FIGS. 6 and 7. In this inoperative position, the protrusions 54′, 56′ are situated on opposite sides of the contact tab 32′. Upon occurrence of a predetermined acceleration, such as occurs in particular during a crash, the centrifugal weight arm can be swiveled about the pivot axis 48′ in opposite directions. In this way, depending on the direction of swiveling, the protrusion 54′ or the protrusion 56′ comes into contact with the contact tab 32′ and presses it upward, so that the end portion 46′ is lifted off from the contact portion 34′ and the electrical connection is broken between the lines 28′ and 30′ and thus between the control element and the electrical drive. In this way, also in this exemplary embodiment an unintentional opening of the doors is securely prevented, for example during a side impact.

### LIST OF REFERENCE NUMBERS

10 Actuating portion
11 Control element
12 Bearing portion
13 Electrical connection
14 Electric drive
16 Housing
16′ Housing
18 Top part
20 Screw connections
22 Bottom part
24 Fastening shoulder
26 Borehole
28 Electrical line
28′ Electrical line
30 Electrical line
30′ Electrical line
32 Contact tab
32′ Contact tab
34 Contact portion
34′ Contact portion
36 Centrifugal weight ball
38 Receptacle
40 Central region
42 Edge
44 Bottom of receptacle
46 End portion
46′ End portion
48′ Pivot axis
50′ Arm portion
52′ Arm portion
54′ Protrusion
56′ Protrusion
58′ Helical spring

1. Arrangement for actuating a component of a vehicle, wherein the component has a manually actuable actuating portion (10) which is mounted on the vehicle so as to be moveable between a closed position and an open position, wherein the arrangement comprises a control element and an electric drive which is connected to the control element via an electrical connection, wherein, when the actuating portion (10) moves into its open position, the control element activates the electric drive, and therefore the electric drive actuates the component, characterized in that a centrifugal weight element is mounted moveably on the arrangement, wherein the centrifugal weight element is moved from an inoperative position into an interruption position by a predetermined acceleration acting on the component and moving the actuating portion (10) into the open position, wherein, in the interruption position the centrifugal weight element interrupts the electrical connection between the control element and the electric drive.

2. Arrangement according to claim 1, characterized in that the actuating portion (10) is moveable from the closed position into the open position by manual pressing-in and/or manual pulling-out and/or manual rotation, and in that the control element comprises a switch, in particular a micro-switch, which is actuated by the movement of the actuating portion (10) into the open position.

3. Arrangement according to claim 1, characterized in that the electrical connection between the control element and the electric drive comprises an elastically deformable contact tab (32, 32′) and a contact portion (34, 34′), which is connected in an electrically conductive manner to the contact tab (32, 32′) in an inoperative position of the contact tab (32, 32′), wherein, when the centrifugal weight element moves into the interruption position, the contact tab (32, 32′) is deformed from the inoperative position into an interruption position in which the electrically conductive connection with the contact portion (34, 34′) is interrupted.

4. Arrangement according to claim 3, characterized in that the centrifugal weight element is a centrifugal weight ball (36) which is mounted in a receptacle (38) below the contact tab (32), wherein the receptacle (38) has a central region (40) of greatest depth that receives the centrifugal weight ball (36) in its inoperative position, and wherein the depth of the receptacle (38) is reduced from the central region (40) of greatest depth towards the edge (42) of the receptacle (38), wherein the centrifugal weight ball (36) is moved from the central region (40) of greatest depth to the edge (42) of the receptacle (38) by the predetermined acceleration which acts on the component and moves the actuating portion (10) into the open position.

5. Arrangement according to claim 4, characterized in that the centrifugal weight ball (36) is pre-tensioned into its inoperative position by the contact tab (32).

6. Arrangement according to claim 5, characterized in that the receptacle (38) is of curved design such that the resetting force acting on the centrifugal weight ball (36) during a movement from the central region (40) of greatest depth to the edge (42) of the receptacle (38) is identical in all directions of movement of the centrifugal weight ball (36).

7. Arrangement according to claim 6, characterized in that the receptacle (38) is conical or frustoconical, or in that the receptacle (38) is arched, preferably is arched spherically.

8. Arrangement according to claim 3, characterized in that the centrifugal weight element is a centrifugal weight arm which is below the contact tab (32′), is mounted pivotably about a pivot axis (48′) and is pivoted by the predetermined acceleration, which acts on the component and moves the actuating portion (10) into the open position, from an inoperative position into an interruption position in which the centrifugal weight arm presses the contact tab (32′) from its inoperative position into its interruption position.

9. Arrangement according to claim 8, characterized in that the centrifugal weight arm is pivotable in two opposed pivoting directions from its inoperative position into its interruption position.

10. Arrangement according to claim 9, characterized in that the centrifugal weight arm is prestressed into its inoperative position by a spring element (58′).

11. Vehicle door of a vehicle with at least one door lock and at least one arrangement which interacts with the door lock, the arrangement being according to claim 1.

12. An arrangement for actuating a component of a vehicle, wherein the component has a manually actuable actuating portion (10) which is moveable between a closed position and an open position, wherein the arrangement comprises a control element and an electric drive which is connected to the control element via an electrical connection, wherein, when the actuating portion (10) moves into its open position, the control element activates the electric drive, wherein a centrifugal weight element is mounted moveably on the arrangement, wherein the centrifugal weight element moves from an inoperative position into an interruption position by a predetermined acceleration acting on the component and moving the actuating portion into the open position, wherein, in the interruption position the centrifugal weight element interrupts the electrical connection between the control element and the electric drive.

13. An arrangement according to claim 12, wherein the actuating portion is moveable from the closed position into the open position by manual pressing-in and/or manual pulling-out and/or manual rotation, and in that the control element comprises a switch that is actuated by the movement of the actuating portion into the open position.

14. An arrangement according to claim 12, wherein the electrical connection between the control element and the electric drive comprises an elastically deformable contact tab (32, 32′) and a contact portion (34, 34′), which is connected in an electrically conductive manner to the contact tab (32, 32′) in an inoperative position of the contact tab (32, 32′), wherein, when the centrifugal weight element moves into the interruption position, the contact tab (32, 32′) is deformed from the inoperative position into an interruption position in which the electrically conductive connection with the contact portion (34, 34′) is interrupted.

15. An arrangement according to claim 14, characterized in that the centrifugal weight element is one of:
a centrifugal weight ball (36) which is mounted in a receptacle (38) below the contact tab (32);
or
a centrifugal weight arm which is below the contact tab (32′).
